(19) United States
(12) Patent Application Publication
(10) Pub. No.: US 2025/0142433 A1
(43) Pub. Date: May 1, 2025

(54) METHODS AND WIRELESS NETWORK FOR PERFORMING CELL RESELECTION WITH SLICES

(71) Applicant: Samsung Electronics Co., Ltd., Gyeonggi-do (KR)

(72) Inventors: Aby Kanneath ABRAHAM, Bangalore (IN); Chadi KHIRALLAH, Middlesex (GB); Hyunjeong KANG, Gyeonggi-do (KR); Sangyeob JUNG, Gyeonggi-do (KR)

(21) Appl. No.: 18/836,637

(22) PCT Filed: Feb. 10, 2023
(86) PCT No.: PCT/KR2023/002032

§ 371 Date: Aug. 7, 2024

(30) Foreign Application Priority Data
Feb. 11, 2022 (IN) 202241007481
Jan. 23, 2023 (IN) 202241007481

(51) Int. Cl. H04W 36/24; H04W 36/00

(52) U.S. Cl. CPC H04W 36/24; H04W 36/0072

(57) ABSTRACT

The disclosure relates to a 5G or 6G communication system for supporting a higher data transmission rate. Embodiments herein disclose methods for handling a slice based cell reselection in a wireless network (1000) by a UE (100). The method includes evaluating a cell reselection criteria based on a relative reselection priority between frequencies derived using a slice priority of at least one slice group supported on a frequency. The at least one slice group comprises a highest priority slice group supported by the frequency as an input. Further, the method includes determining a change in the relative reselection priority upon detecting that a best cell or a highest ranked cell in the frequency does not support the at least one slice group associated with a highest priority. Further, the method includes re-evaluating the cell reselection criteria based on the determined changed in the relative reselection priority.

### TECHNICAL FIELD

Embodiments disclosed herein relate to wireless communication networks, and more particularly to methods and wireless network for performing cell reselection with slices.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present invention has been made to address at least the above problems and/or disadvantages and to provide at least the advantages described below. Accordingly, an aspect of the present invention provides a method and apparatus for performing cell reselection with slices.

### Solution to Problem

The principal object of the embodiments herein is to disclose methods and a wireless network for performing cell reselection with slices.

Another object of the embodiments herein is to perform re-evaluation of cell reselection criteria based on changed priority value.

Another object of the embodiments herein is to disclose about the slice aware cell reselection when a best ranked cell doesn't support highest priority slice.

Another object of the embodiments herein is to disclose about the slice aware cell reselection when a highest ranked cell doesn't support highest priority slice.

Another object of the embodiments herein is to disclose about the slice aware cell reselection when a best cell or highest ranked cell doesn't support any slice.

Another object of the embodiments herein is to disclose methods and the wireless network for performing cell reselection with the slices, where slice specific prioritization information from dedicated signalling is handled.

Another object of the embodiments herein is to disclose methods and the wireless network for performing cell reselection with the slices, wherein a radio access network (RAN) sharing is supported.

Another object of the embodiments herein is to handle a limited service state for slice specific cell reselection with dedicated priorities.

Another object of the embodiments herein is to delete dedicated slice specific priorities using a timer.

### ADVANTAGEOUS EFFECTS OF INVENTION

Advantages, and salient features of the invention will become apparent to those skilled in the art from the following detailed description, which, taken in conjunction with the annexed drawings, discloses exemplary embodiments of the invention. For more enhanced communication system, there is a need for method and network for performing cell reselection with slices.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 is a schematic overview of a wireless network for handling a slice based cell reselection, according to the embodiments as disclosed herein;

FIG. 2 shows various hardware components of a UE, according to the embodiments as disclosed herein;

FIG. 3 is a flow chart illustrating a method for handling the slice based cell reselection in the wireless network based on a cell reselection criteria, according to the embodiments as disclosed herein;

FIG. 4a is an example flow chart illustrating a method for handling a priority reduction after cell reselection evaluation, according to embodiments as disclosed herein;

FIG. 4b is another example flow chart illustrating a method for handling the priority reduction after cell reselection evaluation, according to embodiments as disclosed herein;

FIG. 5 is a flow chart illustrating a method for handling the slice based cell reselection in the wireless network by deleting slice information received from dedicated signalling, according to embodiments as disclosed herein;

FIG. 6 is a flow chart illustrating a method, implemented by the UE, for handling the slice based cell reselection in the wireless network based on a slice operation during RAN sharing, according to embodiments as disclosed herein; and

FIG. 7 is a flow chart illustrating a method, implemented by a network device, for handling the slice based cell reselection in the wireless network based on a slice operation during RAN sharing, according to embodiments as disclosed herein.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following specification particularly describes and ascertains the nature of this invention and the manner in which it is to be performed:

A most prominent feature of fifth generation (5G) networks lies in adopting network slicing for radio access networks (RANs) and core networks (CNs). This is intended for bundling up network resources and network functions into a single independent network slice depending on individual services, allowing for application of network system function and resource isolation, customization, independent management and orchestration to mobile communication network architectures. The use of such network slicing enables offering 5G services in an independent and flexible way by selecting and combining 5G system network functions according to services, users, business models, or such references.

From 3GPP Technical Specification (TS) 38.300 Release 16: A network slice consists of a RAN part and a CN part. The support of network slicing relies on the principle that traffic for different slices is handled by different Protocol Data Unit (PDU) sessions. The wireless network can realize the different network slices by scheduling and also by providing different Layer1 (L1)/(Layer2) L2 configurations.

The network slicing is a concept to allow differentiated treatment depending on each customer requirements. With slicing, it is possible for Mobile Network Operators (MNO) to consider customers as belonging to different tenant types with each having different service requirements that govern in terms of what slice types each tenant is eligible to use based on Service Level Agreement (SLA) and subscriptions.

Some slices may be available only in part of the network. The New Generation Radio Access Network (NG-RAN) supported slice identifiers known as S-NSSAI(s) is configured by an operations, administration and maintenance (OAM). Awareness in the NG-RAN of the slices supported in the cells of its neighbours may be beneficial for inter-frequency mobility in a connected mode. It is assumed that the slice availability does not change within the UE's registration area. The NG-RAN and the 5GC are responsible to handle a service request for a slice that may or may not be available in a given area. Admission or rejection of access to the slice may depend by factors such as support for the slice, availability of resources, support of the requested service by the NG-RAN. In case a User Equipment (UE) is associated with multiple slices simultaneously, only one signalling connection is maintained and for intra-frequency cell reselection, the UE always tries to camp on the best cell.

When some of the slices are supported only in some frequencies, till NR Release 16, the NR networks used, dedicated priorities to control the frequency on which the UE camps. In NR release 17, slice specific prioritization will be introduced. A serving cell can broadcast slice information including the slice support in serving as well as neighboring frequencies, slice specific priorities for serving as well as neighboring frequencies, details on the slice availability in the neighboring cells etc. There may be also some frequencies which may not be associated with any slices. The UE considers the slice priorities of the slices that it needs/supports along with the frequency priorities for the slices during cell reselection. The slices may also be grouped into a set of slices with similar characteristics with respect to slice aware cell reselection, known as slicegroups

Cell reselection: According to 3GPP specification TS 38.300, the cell reselection is the process that identifies the cell that the UE should camp on when UE is in a nonconnected state; i.e., RRC_IDLE and RRC_INACTIVE. It is based on cell reselection criteria. Inter-frequency reselection is based on absolute priorities where the UE tries to camp on the highest priority frequency available. It involves measurements of the serving and neighbour cells. The cell reselection can be speed dependent and in multi-beam operations, the cell quality is derived amongst the beams corresponding to the same cell.

TS 38.304 (extract): Absolute priorities of different NR frequencies or inter-RAT frequencies may be provided to the UE in the system information, in the RRC Release message, or by inheriting from another RAT at inter-RAT cell (re)selection. In the case of system information, a new radio (NR) frequency or inter-RAT frequency may be listed without providing a priority (i.e., the field cellReselectionPriority is absent for that frequency). If priorities are provided in dedicated signalling, the UE shall ignore all the priorities provided in system information. If UE is in camped on any cell state, UE shall only apply the priorities provided by system information from current cell, and the UE preserves priorities provided by dedicated signalling and deprioritisationReq received in RRCRelease unless specified otherwise. When the UE is configured to perform NR sidelink communication or vehicle to everything (V2X) sidelink communication performs cell reselection, it may consider the frequencies providing the intra-carrier and inter-carrier configuration have equal priority in cell reselection.

Absolute priorities are used during cell reselection mainly as below:
a) If a neighbor frequency has lower or equal priority than serving frequency, the UE measures the frequencies for cell reselection only when the serving cell goes below certain threshold decided by the network. If the neighbor frequency has higher priority than the serving frequency then the UE measures those frequencies periodically, irrespective of serving frequency thresholds.
b) The UE performs cell reselection evaluation based on different thresholds and different conditions depending on whether a neighbor frequency is having lower/equal/higher priority than the serving frequency. Usually, the thresholds for lower priority frequencies will be larger than that of higher priority frequencies. If there are multiple neighbor cells that satisfy cell reselection evaluation criteria, UE reselects to neighboring cells belonging to a higher priority frequency. If there are multiple cells satisfying cell reselection criteria within a neighbor frequency, the UE moves to the best cell as defined in the 3GPP TS 38.304. Best cell generally has the highest Reference Signal Received Power (RSRP) or Reference Signal Received Quality (RSRQ) within the frequency.
c) When the cell reselection is intra-frequency cell reselection, i.e. cell reselection to another cell in the same frequency (serving frequency) as that of serving cell, the UE may consider highest ranked cell rather than the best cell for cell reselection. The highest ranked cell needn't be the best cell, for e.g. there may be a neighbor cell having higher RSRP and higher RSRQ than the serving cell, still the serving cell may be considered as highest ranked cell if the difference in RSRP or RSRQ with the best cell is below an offset. All the offsets and thresholds may be provided by the network such as gNB and received by the UE in messages such as system information messages in NR.

Slice aware cell reselection: For slice aware cell reselection (also called slice based cell reselection), the UE may use slice groups—a group of slices supported by the same frequencies and is associated with the same frequency priority within the slice group Slice groups may have same properties, (i.e., are homogeneous) within a NAS registration area.

The NR UE RRC may receive a list of slices or slice groups, and slice priority (priority associated with a slice/slice group) from the NAS layer. A UE NAS layer receives this information from the core network, such as Access and Mobility Management Function (AMF). The UE uses only the slices or slice groups received from the NAS layer for slice based cell reselection. The NR UE RRC also may receive sliceInfoList, a list of sliceInformation, here after called sliceInfo, including an identifier for a slice or slicegroup and a list of frequencies and the priority applicable for individual frequencies for this slice or slicegroup (frequency priority for the slice or slicegroup) from the base station, such as NR gNB. SliceInfo can contain additional information like availability of slice or slice group in neghbouring cells. There can be frequencies without priorities in the sliceInfo and such frequencies may be considered as lowest frequency priority for this slice/slice group. With slice aware cell reselection, the priority used for cell reselection is a combination of both slice priority and frequency priority.

There are two ways by which sliceInfoList could be received by a UE:
a) by broadcast signaling like system information; and
b) by dedicated signalling in RRC messages like RRC release.

The UE performs slice aware cell reselection using the slice priorities and the corresponding frequency priorities provided by the network in the sliceInfo. i.e., the UE performs the measurements and cell reselection evaluation considering the slice priorities and the associated frequency priorities, for e.g., the UE may derive relative cell reselection priorities applying various rules. The rules may be such that the UE considers the frequencies supporting slices/slice groups with higher slice priority as having higher priority than frequencies supporting slices/slice groups with lower slice priority. When more than one frequency has the same associated slice priority, the UE considers frequency priority for the slice/slicegroup, to prioritize those frequencies. When there are frequencies not associated to any slice/slice groups, such frequencies may be considered a having lower priority than frequencies associated with a slice/slice group.

It is possible that a frequency is supporting a slice/slice group, but one or more cells in the frequency does not support the slice/slice group. The network may broadcast the list of cells supporting a slice/slice group (or not supporting a slice/slice group) for each frequency. In such cases, it is beneficial to perform cell reselection considering the slice priority and the frequency priority of the slice or slice group supported by the cell rather than slice or slice group supported by the frequency. In the current systems, such consideration are only based on the best cell in the frequency. Such methods do not work well for intra frequency cell reselection, as for intra frequency cell reselection UE considers highest ranked cell rather than the best cell for cell reselection.

Slice aware cell reselection is also supported by shared networks; for e.g., networks with RAN sharing.

Absolute priorities provided by the network, not considering the slices (i.e. priorities not associated to any slicegroup) can be also referred to as legacy priorities in the context of this invention. The cell reselection not considering the slices and the slice priorities or frequency priorities associated with the slices can be referred to as legacy cell reselection in the context of this invention.

The invention addresses the following problems with respect to slice based cell reselection
a) A UE performs the slice aware cell reselection and calculates the relative cell reselection priorities based on the slice priority or the frequency priority of the slices or slice groups such as the highest priority slice or slice group and performs cell reselection measurements and cell reselection evaluation based on this priority. But when the best ranked cell in a neighbor frequency which satisfied cell reselection criteria does not support the highest priority slice or slicegroup, the UE may reduce the relative cell reselection priority of the frequency with other frequencies, based on slice priority of the highest priority slice or slice group supported on the best cell. However, the UE has already performed evaluation based on old slice priority and hence the UE may still move to the neighbor cell even if the neighbour frequency has become a lower priority frequency in relation to the serving frequency, i.e., relative priority level is reduced and the thresholds for lower priority are not satisfied.
b) In the current systems, above mentioned priority recalculation is applied for the best cell on a frequency and this may not work well for intrafrequency cell reselection. So there is a need for considering highest ranked cell for intrafrequency cell reselection during priority recalculation.
c) The UE can identify the best cell or highest ranked cell only after performing cell reselection measurements or cell reselection evaluation based on the old priorities, i.e. priorities calculated based on the slice groups supported by the frequency. As the UE moves to the neighbor cell that satisfies cell reselection evaluation criteria, the UE may still reselect to a neighbor cell based on the slice priority or the frequency priority of the slice groups not supported by the neighbor cell. There needs to have a method to prevent this anomaly.
d) When the priority recalculation is performed based on the slices or slice groups supported by the best cell, it needs to be defined how the recalculation works when there are no slice groups supported by the best cell.
e) As mentioned, the UE may receive sliceInformationList—i.e. a list of slices/slice groups and frequencies supporting those slices/slice groups and the associated frequency priorities for those slices/slice groups by two ways—broadcast signaling like system information or dedicated signaling like RRC Release.
f) It needs to be defined how the slice aware reselection can be supported with RAN sharing.

Accordingly, the embodiments herein provide methods for handling a slice based cell reselection in a wireless network. The method includes evaluating, by a UE, a cell reselection criteria based on a relative reselection priority between frequencies derived using a slice priority of at least one slice group supported on a frequency. The at least one slice group comprises a highest priority slice group supported by the frequency as an input. Further, the method includes determining, by the UE, a change in the relative reselection priority upon detecting that a best cell or a highest ranked cell in the frequency does not support the at least one slice group associated with a highest priority. Further, the method includes re-evaluating, by the UE, the cell reselection criteria based on the determined changed in the relative reselection priority.

In an embodiment, the UE changes the relative reselection priority by considering the slices supported by the at least one highest ranked cell or the best cell, there by reducing the slice priority to the priority of the highest priority slice group supported by the at least one highest ranked cell or the best cell. The relative reselection priority is provided in accordance with TS 38.304.

In an embodiment, the UE reduces the relative reselection priority by considering a legacy cell reselection priority and sub-priority without considering a slice priority upon determining the best cell or the highest ranked cell does not support all slice groups.

In an embodiment, the change in the relative reselection priority corresponds to a higher priority frequency becoming a lower or equal priority or an equal priority frequency becoming a lower priority frequency.

Accordingly, the embodiments herein provide methods for handling a slice based cell reselection in a wireless network. The method includes receiving, by a UE, at least one slice information from a dedicated signalling message. The at least one slice information comprises a list of supporting frequencies associated with a slice and a priority associated with the slice. Further, the method includes detecting, by the UE, at least one event. Further, the method includes deleting, by the UE, the at least one slice information received from the dedicated signalling message based on at least one detected event. Further, the method includes performing, by the UE, one of a slice aware cell reselection and a non-slice aware cell reselection by applying slice information from a broadcasting signalling message.

In an embodiment, the at least one event comprises at least one of a cell selection event, an inter radio access technology (RAT) cell selection event, a change of a slice group from a Non-access stratum (NAS) signal, a change of a slice information from the NAS signal, a cell reselection to a new radio access (RA) and a updated system information (SI) with a new RA information.

In an embodiment, the at least one slice information received from the dedicated signalling message is stored when the UE is in a limited service state and is used when the UE moves to camped normally state.

In an embodiment, the at least one slice information received from the dedicated signalling message is deleted upon expiry of a timer when the UE is configured by a network entity with a timer, and wherein the UE performs the slice aware cell reselection and uses a broadcasted slice priority.

Accordingly, the embodiments herein provide methods for handling a slice based cell reselection in a wireless network. The method includes receiving, by a UE, at least one slice information with at least one of Public Land Mobile Network identifier (PLMN ID) and a Standalone Non-Public Network (SNPN) ID from at least one of a dedicated signalling message and a system information block (SIB). The at least one slice information comprises at least one of a slice information list and a slice group definition. Further, the method includes applying, by the UE, a part of the at least one slice information related to one of a subscribed PLMN and a subscribed SNPN. Further, the method includes performing, by the UE, the slice based cell reselection upon applying the part of the at least one slice information related to one of the subscribed PLMN and the subscribed SNPN.

Accordingly, the embodiments herein provide a UE. The UE includes a slice based cell reselection controller coupled with a processor and a memory. The slice based cell reselection controller is configured to evaluate a cell reselection criteria based on a relative reselection priority between frequencies derived using a slice priority of at least one slice group supported on a frequency, wherein the at least one slice group comprises a highest priority slice group supported by the frequency as an input. Further, the slice based cell reselection controller is configured to determine a change in the relative reselection priority upon detecting that a best cell or a highest ranked cell in the frequency does not support the at least one slice group associated with a highest priority. Further, the slice based cell reselection controller is configured to reevaluate the cell reselection criteria based on the determined change in the relative reselection priority.

Accordingly, the embodiments herein provide a UE. The UE includes a slice based cell reselection controller coupled with a processor and a memory. The slice based cell reselection controller is configured to receive at least one slice information from a dedicated signalling message, wherein the at least one slice information comprises a list of supporting frequencies associated with a slice and a priority associated with the slice. Further, the slice based cell reselection controller is configured to detect at least one event. Further, the slice based cell reselection controller is configured to delete the at least one slice information received from the dedicated signalling message based on at least one detected event. Further, the slice based cell reselection controller is configured to perform one of a slice aware cell reselection and a non-slice aware cell reselection by applying a slice information from a broadcasting signalling message.

Accordingly, the embodiments herein provide a UE. The UE includes a slice based cell reselection controller coupled with a processor and a memory. The slice based cell reselection controller is configured to receive at least one slice information with at least one of Public Land Mobile Network identifier (PLMN ID) and a Standalone Non-Public Network (SNPN) ID from at least one of a dedicated signalling message and a system information block (SIB). The at least one slice information comprises at least one of a slice information list and a slice group definition. Further, the slice based cell reselection controller is configured to apply a part of the at least one slice information related to one of a subscribed PLMN and a subscribed SNPN. Further, the slice based cell reselection controller is configured to perform the slice based cell reselection upon applying the part of the at least one slice information related to one of the subscribed PLMN and the subscribed SNPN.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein arc intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for handling a slice based cell reselection in a wireless network. The method includes evaluating, by a UE, a cell reselection criteria based on a relative reselection priority between frequencies derived using a slice priority of at least one slice group supported on a frequency, wherein the at least one slice group comprises a highest priority slice group supported by the frequency as an input. Further, the method includes determining, by the UE, a change in the relative reselection priority upon detecting that a best cell or a highest ranked cell in the frequency does not support the at least one slice group associated with a highest priority. Further, the method includes re-evaluating, by the UE, the cell reselection criteria based on the determined changed in the relative reselection priority.

The proposed method ensures that the slice based cell reselection is performed based on the highest priority slicegroup supported by the cell to which the UE is moving rather than the slice groups supported by the frequency, for both intra frequency and inter frequency cell reselections. When the best or highest ranked cell doesn't support any slices, reselection to such cell is deprioritized by considering only the legacy priorities there by ensuring the UE stays in best possible cell or reselects to the best possible cell according to slice based cell reselection. The proposed method can be used for handling dedicated slice based cell reselection information.

Referring now to the drawings, and more particularly to FIGS. 1 through 7, where similar reference characters denote corresponding features consistently throughout the figures, there are shown at least one embodiment.

FIG. 1 is a schematic overview of a wireless network (1000) for handling a slice based cell reselection, according to the embodiments as disclosed herein. In an embodiment, the wireless network (1000) includes a UE (100) and a network device (200). The wireless network (1000) can be, for example, but not limited to, a fourth generation (4G) network, a fifth generation (5G) network, a sixth generation (6G) network, an open radio access network (ORAN) network or the like. The UE (100) can be, for example, but not limited to a computer system, a host server, a personal computer, a smart phone, a Personal Digital Assistant (PDA), a tablet computer, a laptop computer, an Internet of Things (IoT), embedded systems, edge devices, a vehicle to everything (V2X) device or the like. The network device (200) can be, for example, but not limited to, an eNB, an gNB or a base station.

Handling of slice specific prioritization information from dedicated signalling: Consider the case of the UE (100) which has received the sliceInfoList containing the slice information of one or more slices or slice groups, which includes a list of frequencies supporting the slice or slicegroup and the associated frequency priorities applicable for this slice or slice group through dedicated signalling like RRC Release.

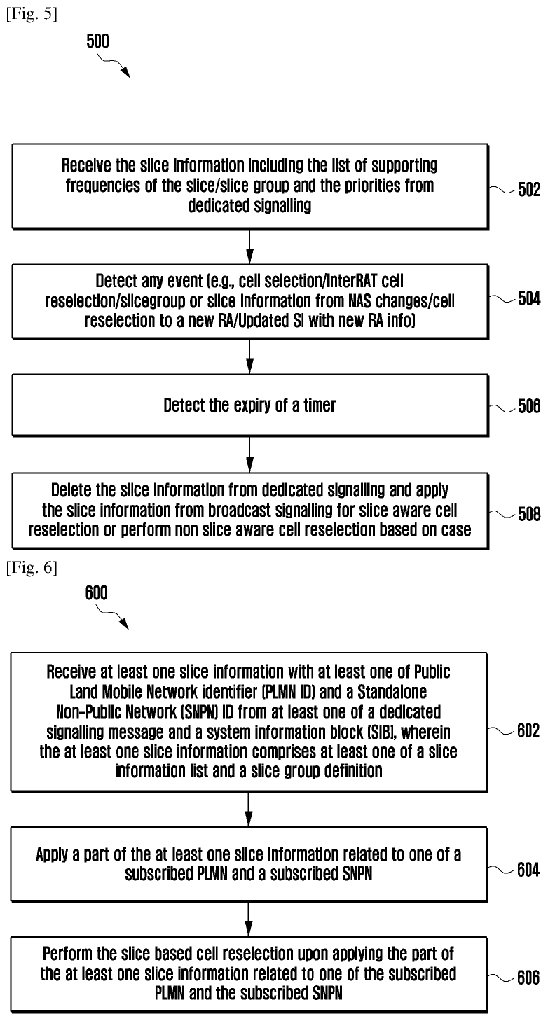

Embodiments herein disclose that the UE (100) deletes the slice information (e.g., sliceInfo as mentioned before including slice specific frequencies and frequency priorities etc.) received from dedicated signalling when one or more of the following events occur (as depicted in FIG. 5).
1. The UE (100) performs inter-RAT cell reselection, i.e., if the UE (100) moves from a new radio (NR) to any other RAT like Long Term Evolution (LTE) or Universal Mobile Telecommunications System (UMTS) OR Global System for Mobile communication (GSM), the UE (100) deletes the slice Information received from the dedicated signalling.
2. The UE (100) moves to limited service state.
3. Slice or Slice group information from the Non-access stratum (NAS) has changed. This may include change of the list of slices/slice groups or the slice priorities.
4. The UE (100) performs cell reselection to a new cell which is in a new registration area.
5. The UE (100) receives an updated NAS system information leading to registration area change.
6. The UE (100) receives RRC Release message with sliceInfoList absent.

In an embodiment, the UE (100) stops slice aware cell reselection when events 1,2,4 or 5 above occur. In another embodiment, the UE (100) continues slice aware cell reselection, but using the broadcasted slice priorities when event 3 or 6 above occur.

In an alternate embodiment, the UE (100) keeps the sliceInfo received from dedicated signaling on moving to limited service state, but does not perform slice aware cell reselection. When the UE (100) moves to camped normally state, sliceInfo received from dedicated signaling could be reused.

In addition to the above events, the UE (100) may be configured by the gNB with a timer and on the expiry of the timer, sliceInformation from dedicated signalling could be deleted. The UE (100) continues slice aware cell reselection, but using the broadcasted slice priorities in this case. In an embodiment, in NR, the timer is T320, used for deleting the dedicated legacy cell reselection priorities.

The UE (100) may also delete the slice Information from dedicated signalling when it enters different RRC STATE or a PLMN selection or SNPN selection is performed.

An example specification according to 3GPP TS 38.304 including the above embodiments is given below:
5.2.4.1 Reselection priorities handling:

### <Some Text>

The UE (100) shall delete priorities provided by dedicated signalling when:
1. the UE (100) enters a different RRC state; or
2. the optional validity time of dedicated priorities (T320) expires; or
3. the UE (100) receives an RRCRelease message with the field cellReselectionPriorities absent; or
4. a PLMN selection or SNPN selection is performed on request by NAS (TS 23.122).

Please note that Equal priorities between RATs are not supported.

The UE (100) shall delete slice specific frequency priorities provided by the dedicated signalling when
a. the UE (100) enters a different RRC state; or
b. the optional validity time of dedicated priorities (T320) expires; or
c. the UE (100) receives an RRCRelease message with the field sliceInfoList absent; or
d. a PLMN selection or SNPN selection is performed on request by NAS (TS 23.122); or
e. the UE (100) performs inter RAT cell reselection; or
f. the UE (100) moves to any cell selection state; or
g. the slice or slice group information received from NAS changes; or
h. the UE (100) performs cell reselection to a cell in a new registration area; or
i. the UE (100) receives an updated NAS system information leading to registration area change.

### <Some Text>

Support of RAN sharing: For the support of RAN sharing, embodiments herein disclose the following methods:
1. The gNB may provide sliceInfoList based on the subscribed PLMN/SNPN of the UE (100).
2. The UE NAS may provide a different list of supported slices to the UE AS based on the subscribed PLMN/SNPN. In an embodiment, this may be received from an Access and Mobility Management Function (AMF) during a NAS registration procedure.
3. The UE (100) may receive SliceInfoList including PLMN Id/SNPN id and a list of SliceInfos mapped to the PLMN Id/SNPN id in broadcast signalling from the gNB. Alternately, the UE (100) may receive multiple sliceInfoLists mapped to PLMN Ids/SNPN ids from the gNB. The UE (100) also may receive the slicegroup definition along with PLMN Id/SNPN id.

The UE (100) applies the sliceInfos or sliceInfoLists based on the subscribed PLMN/SNPN. The UE also (100) considers the slicegroup mapping based on its subscribed PLMN/SNPN. This process has been depicted in FIG. 6.

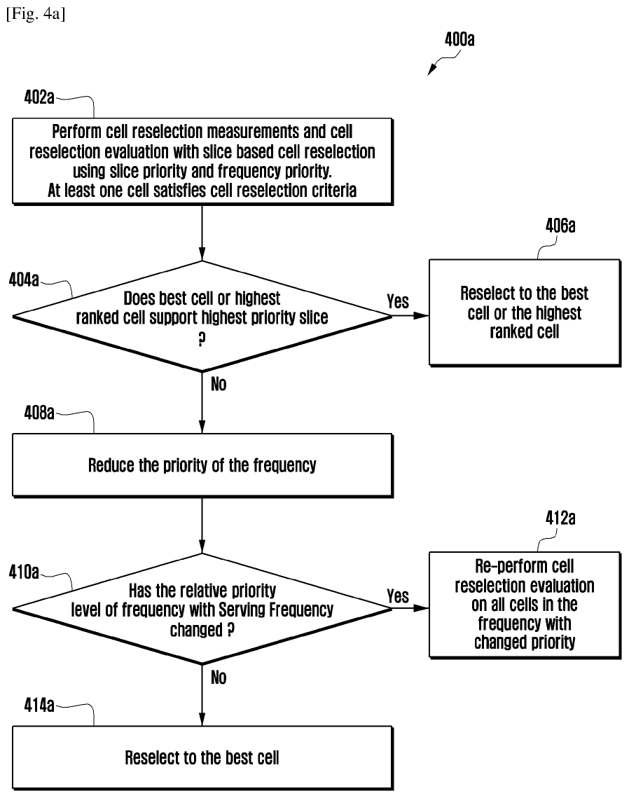

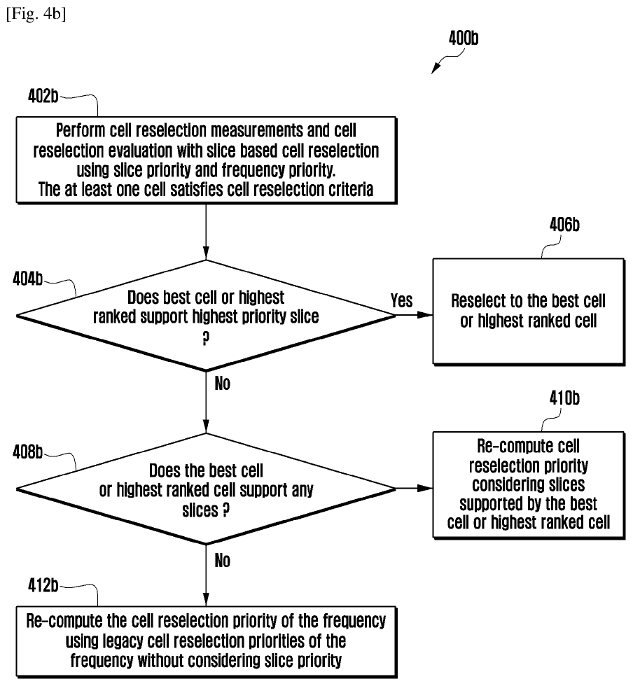

Issue with Priority Reduction after cell reselection evaluation: Embodiments herein propose that the UE (100) performs the slice based cell reselection, which reduces the priority when the best cell or highest ranked cell doesn't support highest priority slice of its frequency, the UE (100) re-evaluates cell reselection criteria based on the reduced priority before performing cell reselection (as depicted in FIG. 4). In an embodiment, the UE (100) may check if the priority reduction leads to reduction in relative priority level, i.e., a higher priority frequency becoming a lower or equal priority, or whether the priority reduction leads to an equal priority frequency becoming a lower priority frequency before performing re-evaluation, as unless the relative priority is changed due to priority reduction, the re-evaluation results in the same results as of the previous evaluation.

The UE (100) may reduce the priority by reducing the slice priority to the priority of highest priority slice supported by the best cell or highest ranked cell or by considering only legacy (NR release 16) cellreselection priority and subpriority, without considering slice priority. If the best cell or highest ranked cell supports at least one slicegroup, the priority can be determined by the priority of the best cell or highest ranked cell. On the other hand, if the best cell or highest ranked cell doesn't support at least one slicegroup, the priority is determined by considering legacy priorities.

An example specification according to 3GPP TS 38.304 is given below:

### 5.2.4.5 NR Inter-Frequency and Inter-RAT Cell Reselection Criteria

If threshServingLowQ is broadcast in system information and more than 1 second has elapsed since the UE (100) camped on the current serving cell, cell reselection to a cell on a higher priority NR frequency or inter-RAT frequency than the serving frequency shall be performed if:
1. A cell of a higher priority NR or EUTRAN RAT/frequency fulfils Squal>ThreshX, HighQ during a time interval TreselectionRAT

Otherwise, cell reselection to a cell on a higher priority NR frequency or inter-RAT frequency than the serving frequency shall be performed if:
a. A cell of a higher priority RAT/frequency fulfils Srxlev>ThreshX, HighP during a time interval TreselectionRAT; and
b. More than 1 second has elapsed since the UE (100) camped on the current serving cell.

The cell reselection to a cell on an equal priority NR frequency shall be based on ranking for intra-frequency cell reselection as defined in clause 5.2.4.6.

If threshServingLowQ is broadcast in system information and more than 1 second has elapsed since the UE (100) camped on the current serving cell, cell reselection to a cell on a lower priority NR frequency or inter-RAT frequency than the serving frequency shall be performed if:
a. The serving cell fulfils Squal<ThreshServing, LowQ and a cell of a lower priority NR or E-UTRAN RAT/frequency fulfils Squal>ThreshX, LowQ during a time interval TreselectionRAT.

Otherwise, the cell reselection to a cell on a lower priority NR frequency or interRAT frequency than the serving frequency shall be performed if:
a. The serving cell fulfils Srxlev<ThreshServing, LowP and a cell of a lower priority RAT/frequency fulfils Srxlev>ThreshX, LowP during a time interval TreselectionRAT; and
b. More than 1 second has elapsed since the UE (100) camped on the current serving cell.

If the UE (100) performs slice-based cell reselection and if the highest ranked cell, according to neighbouring cell information, does not support the highest priority slice supported by its frequency, the UE (100) only considers the slices supported by the highest ranked cell among the NAS provided slice or slice group for slice specific prioritization as in section 5.2.4.X for this frequency, until the highest ranked cell changes or NAS provides a new set of slices of slice groups. If a higher priority frequency becomes an equal or lower priority frequency or if an equal priority frequency becomes a lower priority frequency, due to this change in supported slices, the UE (100) shall re-evaluate the cell selection criteria in this section 5.2.4.5 based on the changed priorities.

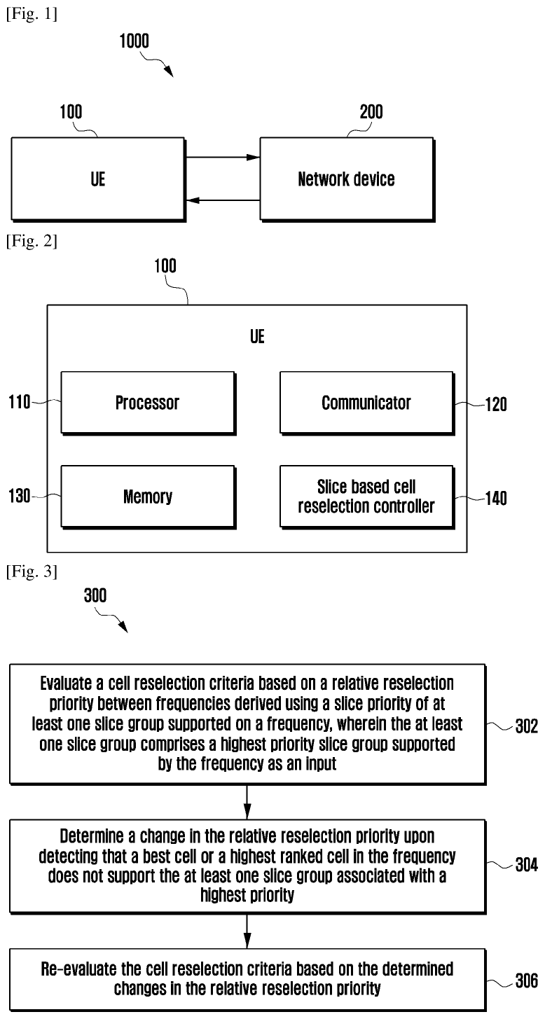

FIG. 2 shows various hardware components of the UE (100), according to the embodiments as disclosed herein. In an embodiment, the UE (100) includes a processor (110), a communicator (120), a memory (130) and a slice based cell reselection controller (140). The processor (110) is coupled with the communicator (120), the memory (130) and the slice based cell reselection controller (140).

In an embodiment, the slice based cell reselection controller (140) evaluate the cell reselection criteria based on the relative reselection priority between frequencies derived using the slice priority of at least one slice group supported on the frequency. The at least one slice group includes a highest priority slice group supported by the frequency as an input. Further, the slice based cell reselection controller (140) determines the change in the relative reselection priority upon detecting that the best cell or the highest ranked cell in the frequency does not support the at least one slice group associated with a highest priority. In an embodiment, the slice based cell reselection controller (140) changes the relative reselection priority by reducing the slice priority to the priority of the highest priority slice group supported by the at least one highest ranked cell or the best cell. In another embodiment, the slice based cell reselection controller (140) reduces the relative reselection priority by considering a legacy cell reselection priority and sub-priority without considering a slice priority upon determining the best cell or the highest ranked cell does not support all slice groups. In another embodiment, the change in the relative reselection priority corresponds to a higher priority frequency becoming a lower or equal priority or an equal priority frequency becoming a lower priority frequency.

The relative reselection priority is provided in accordance with the 3GPP specification TS 38.304 (explained below).

The UE (100) derives reselection priorities for slice-based cell reselection by using:
1. NSAGs and their priorities provided by NAS,
2. sliceInfoList and or sliceInfoListDedicated per frequency with nsag-CellReselectionPriority per NSAG, if provided in system information and/or dedicated signalling, and
3. cellReselectionPriority per frequency provided in system information and/or dedicated signalling.

The UE (100) considers an NR frequency to support all slices of an NSAG if the nsag-ID and TA of the NSAG as provided by NAS are indicated for the NR frequency (scc TS 38.331).

The UE (100) considers a cell on an NR frequency to support all slices of an NSAG if
1. the nsag-ID and TA of the NSAG as provided by NAS are indicated for the NR frequency (see TS 38.331); and
2. the cell is either listed in the sliceAllowedCellListNR (if provided in the used slice-based cell reselection information) or the cell is not listed in the sliceExcludedCellListNR (if provided in the used slice-based cell reselection information); or
3. Neither sliceAllowedCellListNR nor sliceExcludedCellListNR is configured in the used slice-based cell reselection information

The UE (100) shall derive reselection priorities for slice-based cell reselection according to the following rules:
1. Frequencies that support at least one prioritized NSAG received from NAS have higher reselection priority than frequencies that support none of the NSAG(s) received from NAS.
2. Frequencies that support at least one NSAG provided by NAS are prioritised in the order of the NAS-provided priority for the NSAG with highest priority supported on the frequency.
3. Among the frequencies (one or multiple) that support the highest prioritised NSAG(s) with the same NAS-provided priorities, the frequencies are prioritized in the order of their highest nsag-CellReselectionPriority given for these NSAG(s). If no nsag-CellReselectionPriority is given for a NSAG at a frequency, the lowest priority value is used (i.e., lower than any of the network configured values for these frequencies).
4. Frequencies that support none of the NSAG(s) provided by NAS are prioritized in the order of their cellReselectionPriority;

Based on the determined changed in the relative reselection priority, the slice based cell reselection controller (140) re-evaluates the cell reselection criteria

In another embodiment, the slice based cell reselection controller (140) receives at least one slice information from the dedicated signalling message. The at least one slice information includes the list of supporting frequencies associated with the slice and the priority associated with the slice. Further, the slice based cell reselection controller (140) detects at least one event. The at least one event can be, for example, but not limited to at least one of the cell selection event, the RAT cell selection event, the change of a slice group from the NAS signal, the change of a slice information from the NAS signal, the cell reselection to the new RA and the updated SI with a new RA information. Based on at least one detected event, the slice based cell reselection controller (140) deletes the at least one slice information received from the dedicated signalling message. Further, the slice based cell reselection controller (140) performs one of the slice aware cell reselection and the non-slice aware cell reselection by applying slice information from the broadcasting signalling message.

In an embodiment, the at least one slice information received from the dedicated signalling message is stored when the UE (100) is in the limited service state and is used when the UE (100) moves to camped normally state.

In an embodiment, the at least one slice information received from the dedicated signalling message is deleted upon expiry of the timer when the UE (100) is configured by the network entity (200) with the timer. The UE (100) performs the slice aware cell reselection and uses the broadcasted slice priority.

In another embodiment, the slice based cell reselection controller (140) receives at least one slice information with at least one of PLMN ID and the SNPN ID from at least one of the dedicated signalling message and the SIB. The at least one slice information includes at least one of a slice information list and a slice group definition. Further, the slice based cell reselection controller (140) applies a part of the at least one slice information related to one of a subscribed PLMN and a subscribed SNPN. Further, the slice based cell reselection controller (140) performs the slice based cell reselection upon applying the part of the at least one slice information related to one of the subscribed PLMN and the subscribed SNPN.

The slice based cell reselection controller (140) is physically implemented by analog and/or digital circuits such as logic gates, integrated circuits, microprocessors, micro-controllers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 3 is a flow chart (300) illustrating a method for handling the slice based cell reselection in the wireless network (1000) based on the cell reselection criteria, according to the embodiments as disclosed herein. The operations (302-306) are handled by the slice based cell reselection controller (140).

At 302, the method includes evaluating the cell reselection criteria based on the relative reselection priority between the frequencies derived using the slice priority of at least one slice group supported on the frequency. The at least one slice group includes the highest priority slice group supported by the frequency as the input. At 304, the method includes determining the change in the relative reselection priority upon detecting that the best cell or the highest ranked cell in the frequency does not support the at least one slice group associated with the highest priority. At 306, the method includes re-evaluating the cell reselection criteria based on the determined changes in the relative reselection priority.

FIG. 4a is an example flow chart (400a) illustrating a method for handling the priority reduction after cell reselection evaluation, according to embodiments as disclosed herein. The operations (S402a-S414a) are handled by the slice based cell reselection controller (140).

At 402a, the method includes performing the cell reselection measurements and cell reselection evaluation with the slice based cell reselection using slice priority and frequency priority. At least one cell satisfies cell reselection criteria. At 404a, the method includes determining whether the UE (100) does the best cell or highest ranked cell supporting highest priority slice? If the UE (100) does have the best cell or highest ranked cell supporting the highest priority slice, at 406a, the method includes reselecting to the best cell or highest ranked cell. If the UE (100) does not have the best cell or highest ranked cell supporting the highest priority slice, at 408a, the method includes reducing the priority of the frequency.

At 410a, the method includes determining whether the UE (100) has the relative priority level of frequency with the serving frequency changed? If the UE (100) has the relative priority level of frequency with the serving frequency changed, At 412a, the method includes re-performing the cell reselection evaluation on all cells in the frequency with changed priority. If the UE (100) does not have the relative priority level of frequency with the serving frequency changed, at 414a, the method includes reselecting to the best cell.

FIG. 4b is another example flow chart (400b) illustrating a method for handling the priority reduction after cell reselection evaluation, according to embodiments as disclosed herein. The operations (S402b-S414b) are handled by the slice based cell reselection controller (140).

At S402b, the method includes performing the cell reselection measurements and cell reselection evaluation with the slice based cell reselection using the slice priority and the frequency priority. The at least one cell satisfies the cell reselection criteria. At S404b, the method includes determining whether the best cell or the highest ranked supports the highest priority slice? If the best cell or the highest ranked cell supports the highest priority slice then, at S406b, the method includes reselecting to the best cell or the highest ranked cell. If the best cell or the highest ranked cell does not support the highest priority slice then, at S408b, the method includes determining whether the best cell or highest ranked cell supports any slices? If the best cell or the highest ranked cell supports any slices then, at 410b, the method includes re-computing the cell reselection priority considering slices supported by the best cell or the highest ranked cell. If the best cell or the highest ranked cell does not support any slices then, at 412b, the method includes re-computes the cell reselection priority of the frequency using legacy cell reselection priorities of the frequency without considering slice priority.

FIG. 5 is a flow chart (500) illustrating a method for handling the slice based cell reselection in the wireless network (1000) by deleting slice information received from dedicated signalling, according to embodiments as disclosed herein. The operations (S502-S506) are handled by the slice based cell reselection controller (140).

At 502, the method includes receiving the slice information including the list of supporting frequencies of the slice/slice group and the priorities from dedicated signalling. At 504, the method includes detecting the event. At S506, the method includes detecting the expiry of the timer. At 508, the method includes deleting the at least one slice information received from the dedicated signalling message based on at least one detected event and upon expiry of the timer. Also, the method includes performing one of the slice aware cell reselection and the non-slice aware cell reselection by applying slice information from a broadcasting signalling message.

FIG. 6 is a flow chart (600) illustrating a method, implemented by the UE (100), for handling the slice based cell reselection in the wireless network (1000) based on the slice operation during RAN sharing, according to embodiments as disclosed herein. The operations (S602-S606) are handled by the slice based cell reselection controller (140).

At 602, the method includes receiving the at least one slice information with at least one of PLMN ID and the SNPN ID from at least one of the dedicated signalling message and the SIB. The at least one slice information comprises at least one of the slice information list and the slice group definition. At 604, the method includes applying the part of the at least one slice information related to one of a subscribed PLMN and a subscribed SNPN. At 606, the method includes performing the slice based cell reselection upon applying the part of the at least one slice information related to one of the subscribed PLMN and the subscribed SNPN.

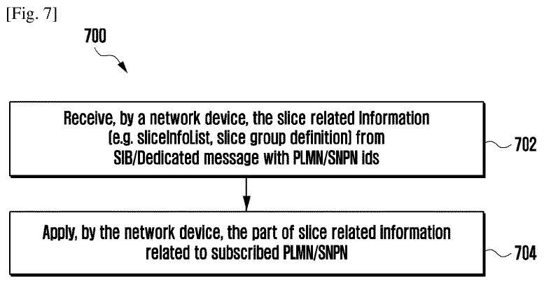

FIG. 7 is a flow chart (700) illustrating a method, implemented by the network device (200), for handling the slice based cell reselection in the wireless network (1000) based on the slice operation during RAN sharing, according to embodiments as disclosed herein. At 702, the method includes receiving the slice related Information (e.g., sliceInfoList, slice group definition) from the SIB/Dedicated message with the PLMN/SNPN IDs. At 704, the method includes applying the part of slice related information related to subscribed PLMN/SNPN.

The various actions, acts, blocks, steps, or the like in the flow charts (300-700) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method for handling a slice based cell reselection in a wireless network, comprises:
evaluating a cell reselection criteria based on a relative reselection priority for at least one frequency, wherein a frequency of the at least one frequency support at least one slice group including a highest priority slice group;
identifying whether a best cell or a highest ranked cell in the frequency support the highest priority slice group;
changing the relative reselection priority, in case that that the best cell or the highest ranked cell in the frequency does not support the highest priority slice group; and
re-evaluating the cell reselection criteria based on the changed relative reselection priority.

2. The method of claim 1, changing the relative reselection priority comprising:
reducing the slice priority to a priority of the highest priority slice group supported by the highest ranked cell or the best cell.

3. The method of claim 1, changing the relative reselection priority comprising:
considering a legacy cell reselection priority and sub-priority without considering a slice priority, in case that the best cell or the highest ranked cell does not support all slice groups.

4. The method of claim 1,
wherein changing the relative reselection priority comprising a higher priority frequency becoming a lower or equal priority or an equal priority frequency becoming a lower priority frequency, and
wherein the relative reselection priority between frequencies are derived using a slice group priority of the at least one slice group supported by the frequency.

5. The method of claim 1, the method further comprising:
receiving, from a base station, a dedicated signaling message including at least one slice information including a list of frequencies associated with a slice and a priority associated with the slice;
detecting at least one event;
deleting the at least one slice information based on the detection of the at least one event; and
performing a cell reselection among a slice aware cell reselection or a non-slice aware cell reselection applying slice information receiving from a broadcasting signaling message.

6. The method of claim 5,
wherein the at least one event including at least one of a cell selection event, an inter radio access technology (RAT) cell selection event, a change of a slice group information from a Non-access stratum (NAS) signal, a change of a slice information from the NAS signal, a cell reselection to a new radio access (RA) and a updated system information (SI) with a new RA information.

7. The method of claim 5, the method further comprising:
storing the at least one slice information in the UE, in case that the UE is in a limited service state; and
using the at least one slice information stored in the UE, in case that the UE moves to a camped normally state.

8. The method of claim 5, the method further comprising:
deleting the at least one slice information upon expiry of a timer configured by a network entity; and
performing the slice aware cell reselection using a broadcasted slice priority.

9. A terminal for handling a slice based cell reselection in a wireless network, the terminal comprising:
a transceiver configured to transmit and receive a signal; and
a controller coupled with the transceiver and configured to:
evaluate a cell reselection criteria based on a relative reselection priority between frequencies, wherein a frequency support at least one slice group including a highest priority slice group;
identify whether that a best cell or a highest ranked cell in the frequency support the highest priority slice group;
change the relative reselection priority, in case that that the best cell or the highest ranked cell in the frequency does not support the highest priority slice group; and
re-evaluate the cell reselection criteria based on the changed relative reselection priority.

10. The terminal of claim 9, the controller is further configured to:
reduce the slice priority to a priority of the highest priority slice group supported by the highest ranked cell or the best cell.

11. The terminal of claim 9, the controller is further configured to:
consider a legacy cell reselection priority and sub-priority without considering a slice priority, in case that the best cell or the highest ranked cell does not support all slice groups.

12. The terminal of claim 9,
wherein changing the relative reselection priority comprising a higher priority frequency becoming a lower or equal priority or an equal priority frequency becoming a lower priority frequency, and
wherein the relative reselection priority between frequencies are derived using a slice group priority of the at least one slice group supported by the frequency.

13. The terminal of claim 9, the controller is further configured to:
receive, from a base station, a dedicated signaling message including at least one slice information including a list of frequencies associated with a slice and a priority associated with the slice;
detect at least one event;
delete the at least one slice information based on the detection of the at least one event; and
perform a cell reselection among a slice aware cell reselection or a nonslice aware cell reselection applying slice information receiving from a broadcasting signaling message,
wherein the at least one event including at least one of a cell selection event, an inter radio access technology (RAT) cell selection event, a change of a slice group information from a Non-access stratum (NAS) signal, a change of a slice information from the NAS signal, a cell reselection to a new radio access (RA) and a updated system information (SI) with a new RA information.

14. The terminal of claim 13, the controller is further configured to store the at least one slice information, in case that the UE is in a limited service state; and
use the at least one slice information stored in the UE, in case that the UE moves to a camped normally state.

15. The method of claim 13, the controller is further configured to:
delete the at least one slice information upon expiry of a timer configured by a network entity; and
perform the slice aware cell reselection using a broadcasted slice priority.
